(19) United States
(12) Patent Application Publication
(10) Pub. No.: US 2014/0091508 A1
(43) Pub. Date: Apr. 3, 2014

(54) INTEGRATED FOLDING CUTLERY RETAINING AND CUTTING BOARD APPARATUS

(71) Applicant: Paul R. Chalifoux, Wellesley, MA (US)

(72) Inventor: Paul R. Chalifoux, Wellesley, MA (US)

(21) Appl. No.: 13/633,298

(22) Filed: Oct. 2, 2012

(51) Int. Cl. A47J 47/16; A47J 43/00

(52) U.S. Cl. 269/16; 206/553

(57) ABSTRACT

A kitchen apparatus including a combined utensil retainer member and drying rack member, encapsulated within a rotatably attached cutting board mechanism. The cutting board mechanism includes a containment apparatus on the underside such that food, liquids, debris and the like are deflected from entering the internal portion of the cutlery holding area. The overall apparatus combines an upper and lower portion, both of which utilize numerous embodiments interchangeably in order to retain utensils and provide cutlery ability.

### CROSS REFERENCE TO RELATED APPLICATION

This application is a Continuation-in-Part application and claims the benefit of and takes priority from U.S. patent application Ser. No. 13,317,699 filed on Oct. 26, 2011, the contents of which are hereby incorporated by reference.

### BACKGROUND OF THE INVENTION

1. Field of the Invention

This invention relates to apparatuses and systems for usage and storage of cutlery and accompanying devices, and more particularly to integrated systems which retain the cutlery and may be converted into apparatuses for utilizing the cutlery.

2. Description of the Related Art

Presently, cutlery and other such flatware is sold in sets of several knives each with a different purpose and a consumer is normally free to purchase knives which are bought individually or in sets. Individual knives are placed in draws, boxes or silverware bins. In the state of the art, cutlery sets are difficult to store and require excessive room on counter tops. It would be desirable to reduce the foot print of present day cutlery sets and even combine their use with other home wares such as a cutting board.

It would also be desirable to encompass a design which allows for easy access for utensil removal and placement combined with maximum space efficiency for placement of the maximum number of utensils. It is desirable to have utensils oriented in such a way as to minimize accidents such as cuts and punctures. In addition, it is desirable to have utensils fit securely with minimal to no movement during usage, movement and storage.

In the state of the art, cutting boards are made of wood, ceramic or plastic. They come in various sizes and are used for cutting various types of food. They are easily stored on their side with a minimal foot print on the counter top by placing them against a wall on their side. In many kitchens, they stay on a counter top as a useful decorative piece.

It would be desirable to have a cutting board which opened to hold knifes, knife sets, silverware, knife sharpeners, scissors or the like. The cutting board would close while containing a knife set for example, and be stored on its side like a regulate cutting board. When it is time to cut food, the cutting board is removed from its storage place, the necessary knives removed and cutting food completed. It is desirable to minimize food contents from entering into the area storing knives, silverware or the like.

After cutting food, it is desirable to clean the cutting board surface without getting internal areas wet from water or contaminated with food and debris. It would be desirable to provide a seal as occurs with a gasket or rubber interlock which prevents materials from entering the internal portion, a design which deflects materials and or a design which allows removal of the cutting board for cleaning. It would be further desirable to have a design which allows for replacement of or covering over with a new cutting board after years of wear.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses for creating and utilizing a collapsible cutlery retaining, dish rack and cutting board apparatus illustrated. Thus the several embodiments of the instant apparatus are illustrated herein.

It is primary object of the present multifunctional apparatus to introduce and utilize an upper member comprising a cutting board in communication with a lower retaining or utensil retaining apparatus, wherein the upper member encloses and encapsulates the utensil retaining apparatus. Herein, aside from knives, cutlery is understood to include, but not be limited to, any other kitchen utensils such as potato peelers, potato mashers, egg cutters, straining spoons, spatulas, barbecue utensils, or any kitchen device which is easily contained in a box the size of a cutting board. The cutting board when closed possesses sides which cover most sides of the area holding cutlery. The area disposed for retaining cutlery may be a box, a board with partial or several sides, a board with one side above it or a board with no sides above it.

Also, within this versatile system, knives may be retained in clips, slots, bins or like areas and may be oriented sideways, with the cutting edge up or with the cutting edge down. Also, draws may be utilized and these may open from side surfaces. Utensils, particularly knives, may be retained on the bottom board, in draws, or on the inner portion of the box formed inside the cutting board portion. Knife handles are accessible by leaving areas open for fingers to maneuver to handles, by have holders pivot and swing open, or by leaving open areas to slide knives. Moreover, due to multipurpose nature of the system, coffee, tea, spices and other house ware supplies may also be stored within the lower retaining apparatus.

Finally, it is an object of the instant system to the introduce a multifaceted cutting board, dish rack and object retaining system which includes a portable embodiment and also a rigidly affixed embodiment which may exist as a permanent counter top, or as part of counter top and/or as part of a sink.

There has thus been outlined, rather broadly, the more important features of the versatile integrated folding cutlery retaining, dish rack and cutting board apparatus embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of exemplary embodiments thereof, which description should be considered in conjunction with the accompanying drawings. Having thus described the invention in general terms, reference will now be made to the accompanying drawings, which are not necessarily drawn to scale, and wherein:

FIG. 1 illustrates a customary knife box where the top hinges to close a top onto the top sides of a box holding knifes and the multipurpose cutting board apparatus embodiment of the present system wherein the underside of the cutting board includes a box which closes over and around the cutlery holder;

FIG. 2 illustrates one embodiment of the multipurpose cutting board apparatus wherein many knives and a cutting board with hinges to are utilized to close and open;

FIG. 3 illustrates one embodiment of the multipurpose cutting board apparatus wherein the knife holding areas pivot and swing open within a box form to allow removal;

FIG. 4 illustrates one embodiment of the multipurpose cutting board apparatus wherein knives to be placed into sideway slots;

FIG. 5 illustrates an advanced embodiment of the multipurpose cutting board apparatus wherein the cutting board is connected to the knife holder with a support arm and wherein the support arm raises the knife holder for knife removal when the cutting board is open and presses the knife holder down when closed.

FIG. 6 illustrates a cutting board embodiment of the multipurpose cutting board apparatus wherein knives are retained with use of clips.

FIG. 7 illustrates a cutting board embodiment of the multipurpose cutting board apparatus wherein knives are retained and wherein a dish drying rack is also included.

FIG. 8 illustrates a cutting board embodiment of the multipurpose cutting board apparatus which utilizes knives and comprises bins to retain knives, silverware and the like.

FIG. 9 illustrates a cutting board embodiment of the multipurpose cutting board apparatus which utilizes a removable cutting board for cleaning or for placement of a replacement or decorative cutting board.

FIG. 10 illustrates an isometric view of the multipurpose cutting board apparatus, wherein the instant apparatus is embedded within a sink or counter and wherein the water and refuse drains into the sink.

FIG. 11 illustrates a side view of the multipurpose cutting board apparatus wherein the instant apparatus is embedded within a sink or counter, further illustrating a drainage system wherein the water is routed directly into the drainage system of the sink.

FIG. 12 illustrates an isometric view of the multipurpose cutting board apparatus, illustrating two cutting boards, one in the open position and the other in the closed position.

### DETAILED DESCRIPTION OF THE SEVERAL EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

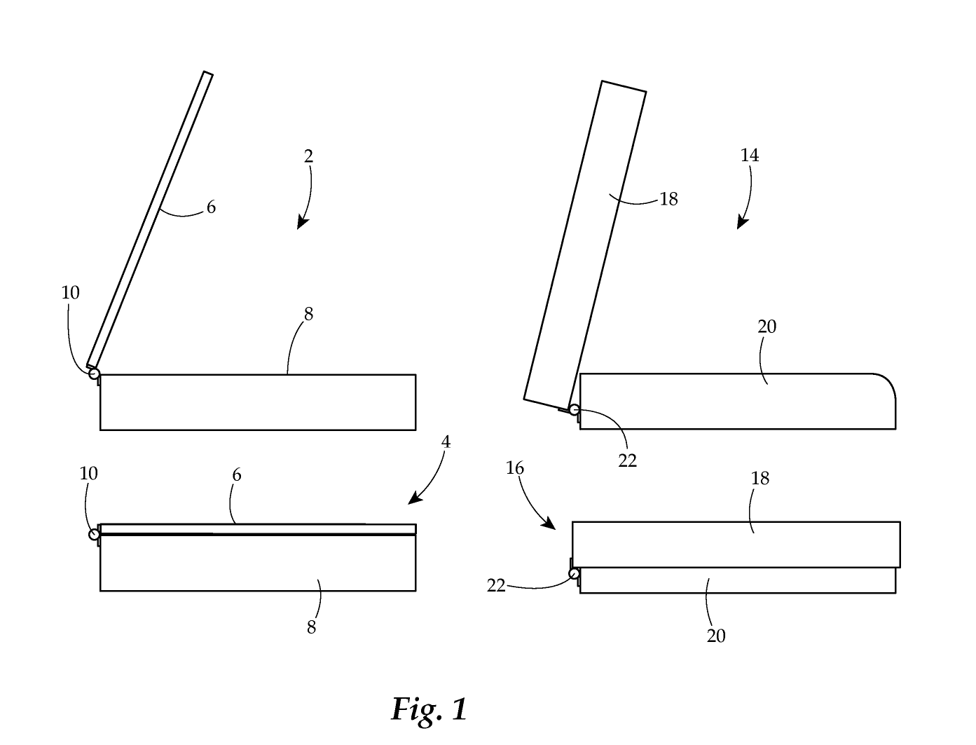

FIG. 1 illustrates a state of the art cutlery box 2 in the open position and the same box 4 in the closed position. Top 6 rotates on hinge 10 and is disposed to rest on top of box 8 when placed in the closed position. The present invention cutting board cutlery box 14 in the open position and 16 in the closed position rotates on hinge 22 closing cutting board portion 18 over cutlery holding portion 20 such that cutting board 18 is supported by components hitting cutting board 18 to cutlery holder 20 or to the counter top for stability during use. Cutting board 18 has a general box containment apparatus on the underside such that food, liquids, debris and the like are deflected from entering the internal portion of the cutlery holding area 20. The box walls of cutting board 18 may be partially covering or complete. For example, the walls may only extend ¼ of the way down as might be necessary to properly install and actuate the hinged area. The hinge 22 may be solid or allow detachment of cutting board 18 from cutlery holder 20.

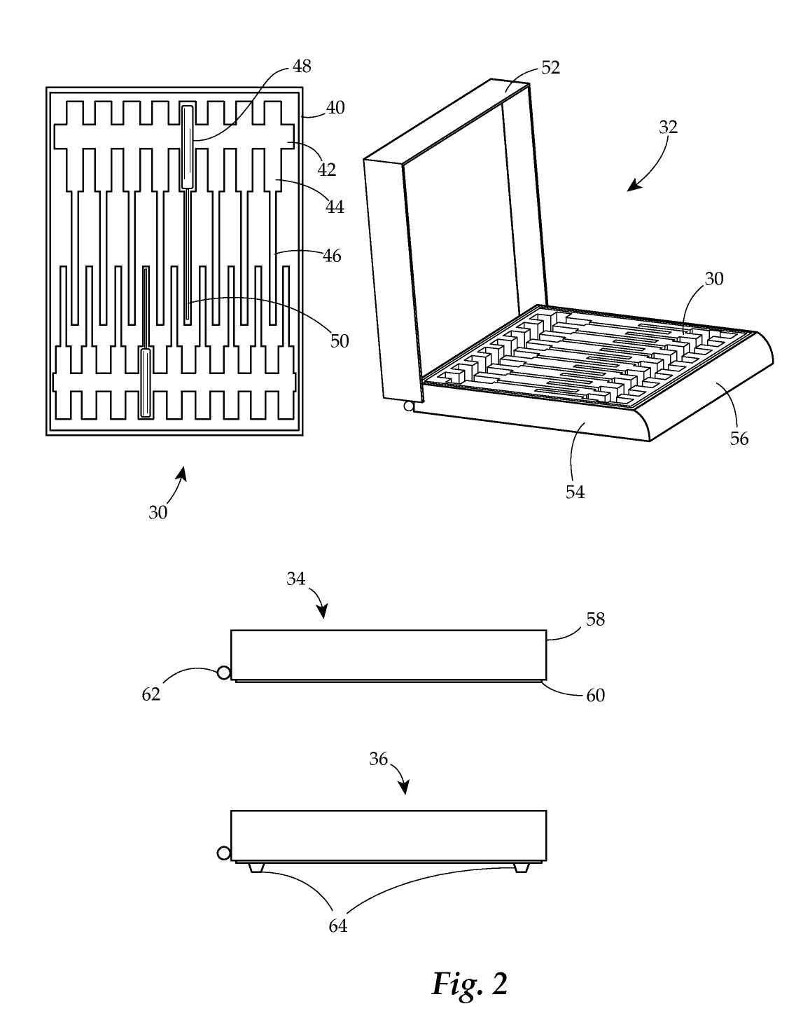

FIG. 2 shows the basic cutting board cutlery holder design. Tray 30 is placed into cutlery holder 54 to hold knives. Slot 46 holds knife blade 50 and slot 44 holds knife handle 48. Bin 42 contained within walls 40 provide a space to expose the end of handle 48 to allow access for fingers to hold and remove knifes. Bin 42 can be located at the extremity or end portion on handles 48 or in the middle portion. Cutlery holder cutting board 32 is in the open position such that cutting board 52 is up allowing access to cutlery holder 54. Cutlery holder 54 can be a flat board with holders or a box form. It can have slots or bins or allow placement of a removable tray 30. End portion 56 of cutlery holder 54 can be rounded to allow rotation of the cutting board 52 over it.

Cutting board cutlery holder 34 and 36 show the closed position. In the closed position, hinge 62 is inside or outside of the device to close cutting board 58. The bottom edge 60 of cutting board 58 is supported on to the counter top or short of it and supported against portions of the cutlery holder. Stability of the device is further improved with small feet made of any material but preferably rubber or plastic.

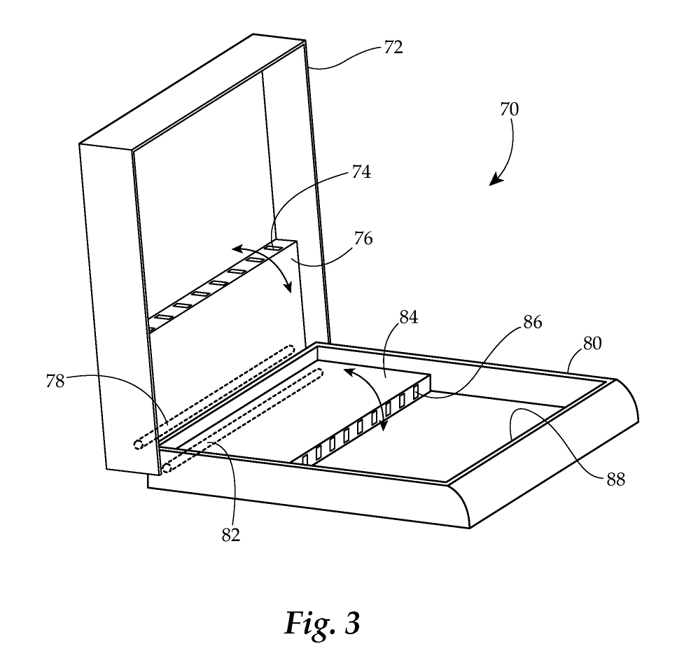

FIG. 3 shows cutting board cutlery holder 70 with cutting board 72 and cutlery board 80. Within cutting board 72 is knife holder 76 which has knife holding slots 74. Within cutlery board 80 is knife holder 84 with knife holding slots 86. Knife holder 84 rotates on hinge 82 to lift up and allow removal of knives which would hit wall 88 of cutlery board 80 and prevent removal if it did not lift up. Hinge 78 allows rotation of knife holder 74 to allow knife removal.

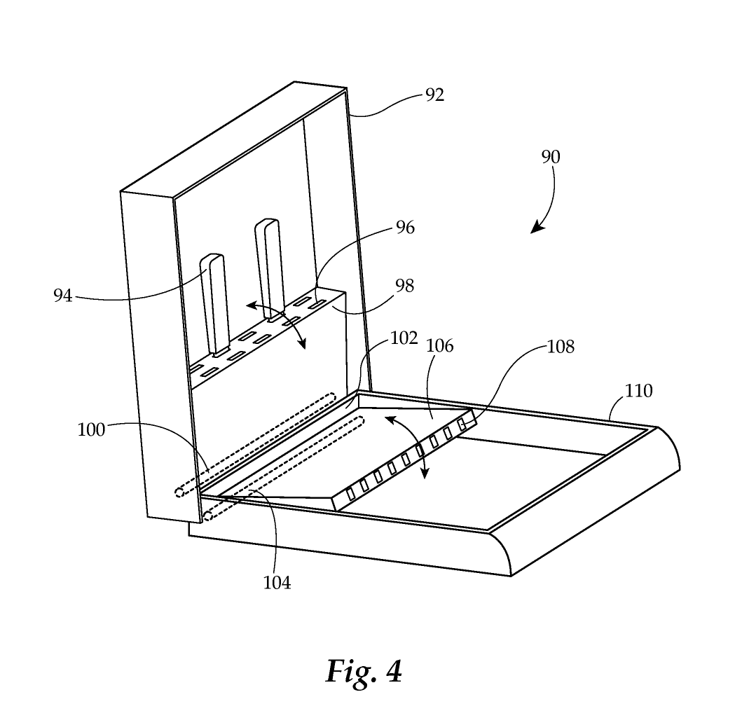

FIG. 4 shows cutting board cutlery holder 90 with cutting board 92 and cutlery holding board 110. Cutting board 92 supports knife holder 98 which has knife holding slots 96 to secure knife 94. Knife holder 98 rotates on hinge 100 to allow removal of knife 94. Cutlery holding board 110 has knife holder 106 and knife holding slots 108 which rotates on hinge 104 to allow knife removal.

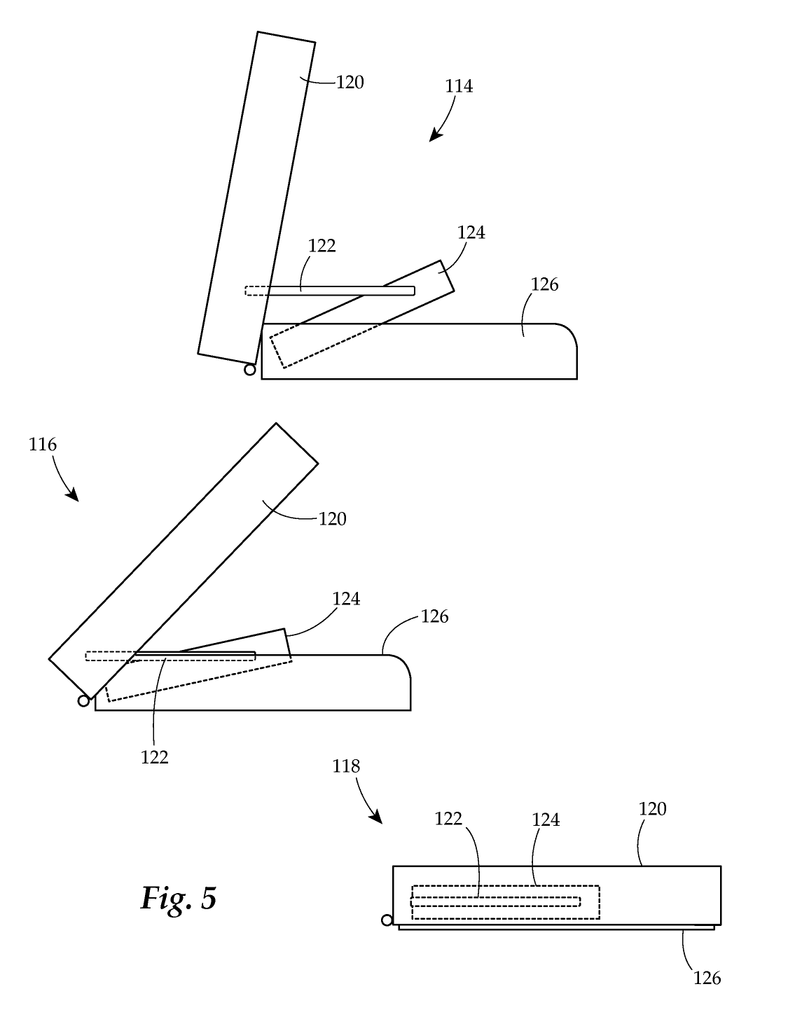

FIG. 5 shows cutting board cutlery holder 114 with cutting board 120 which is connected to support arm 122 to knife holder 124. Knife holder 124 is attached by hinge to cutlery board 126. When cutting board 120 opens, support arm 122 lifts knife holder 124 to allow knife removal. The cutting board cutlery holder 166 and 188 illustrate both partial closure and complete closure embodiments.

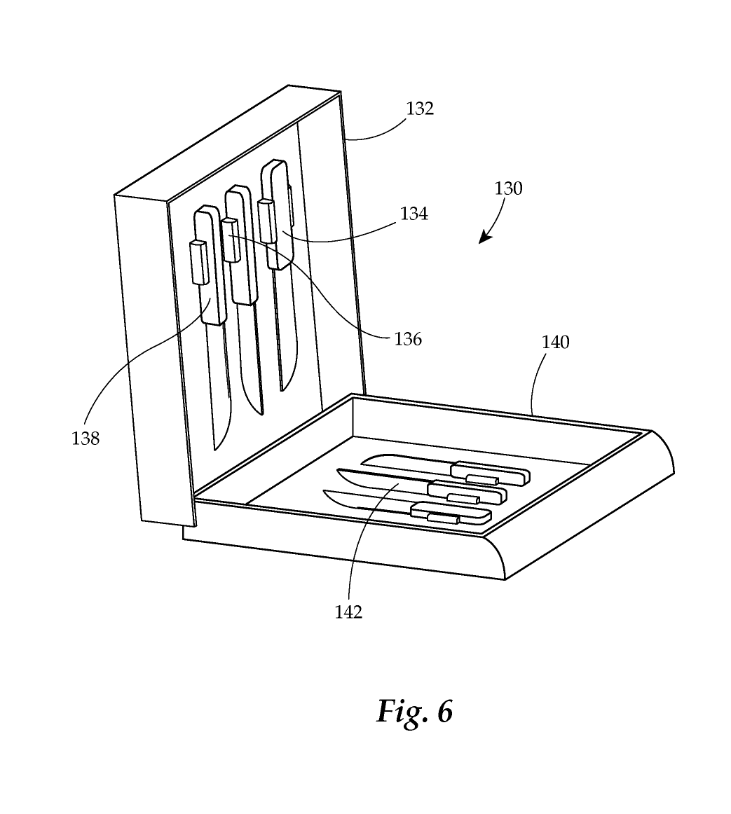

FIG. 6 shows cutting board cutlery holder 130 with cutting board 132 and cutlery board 140. Knifes 134, 138 and 142 reveal different orientation of knifes such that cutting edges may be down, up or sideways. The knives are held in with clips 136 however, bins or slots are preferred.

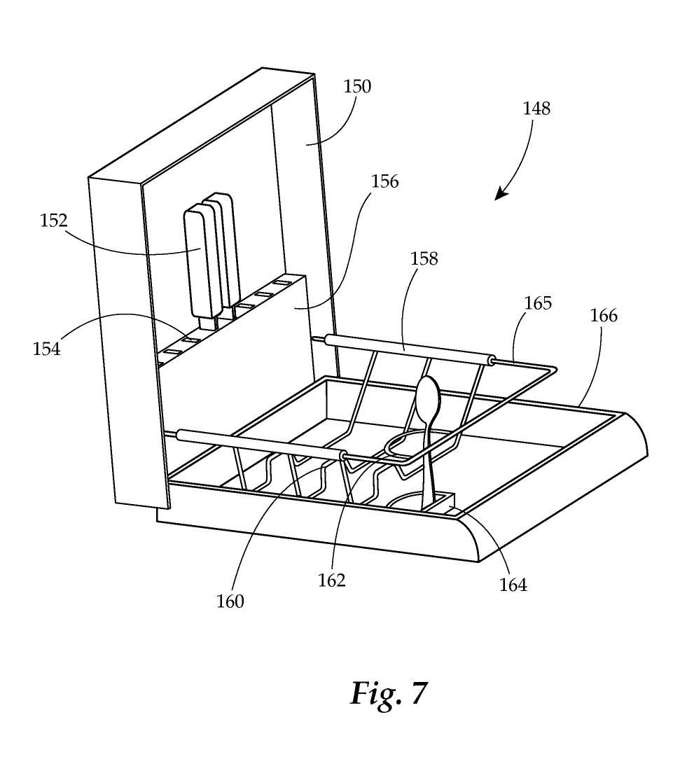

FIG. 7 shows cutting board dish drying rack 148. Cutting board 150 contains knife holder 156 with knife holding slots 154. Dish drying rack board 166 supports silverware holder 162 and 164, plate supports 160 which opens and closes by support are 158. Support are 158 are attached to cutting board 150 and plate supports 160 by hinges allowing the components to close within the cutting board when closed.

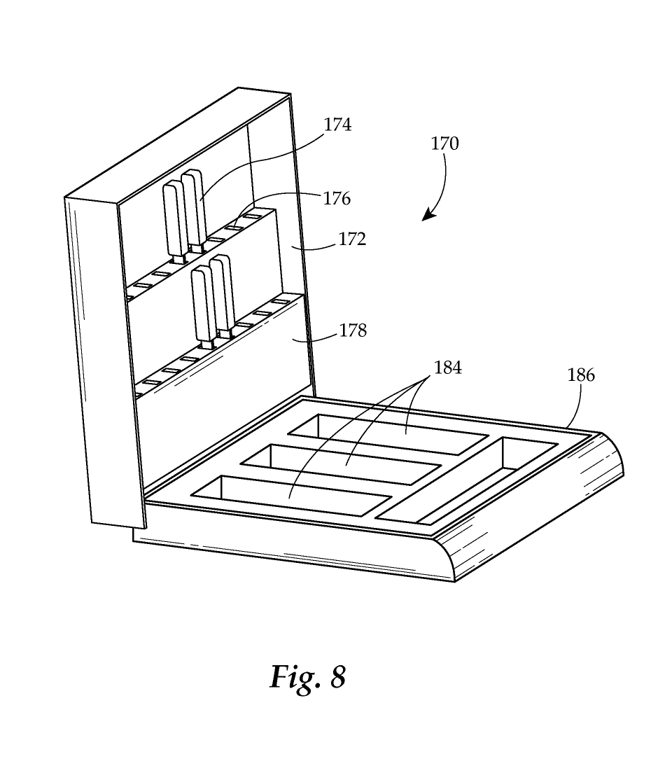

FIG. 8 shows cutting board cutlery holder 170 with cutting board 172 and cutlery holder 186. Cutting board 172 has knife holder 178 with knife slots 176 which hold knifes 174. Cutlery board 186 has bins 184 which hold knives, silverware or the like. The bins may be one large bin or many bins of various sizes and shapes.

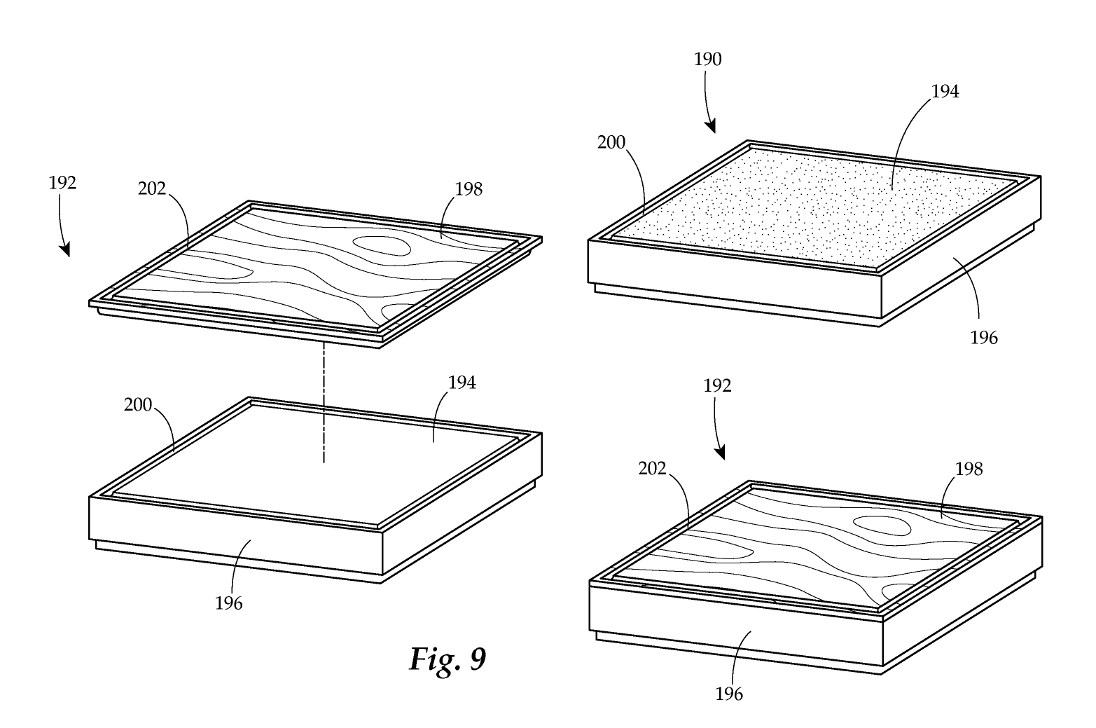

FIG. 9 shows cutting board cutlery holder 190 with top cutting board surface 194 with indentation 200 to contain liquids and debris on the board surface. Cutting board cutlery holder 192 show cutting board 198 attached to the top of cutting board cutlery holder 192. Indentation 202 provides containment of liquid and debris and protrusions under lock into slot 200 for stability. Cutting board 198 allows replacement of cutting boards which may be required from age and use, placement of different decorative boards such as ceramic or wood for an improved appearance.

In one embodiment, the system and accompanying apparatuses may include a cutlery retaining apparatus comprising, a lower portion and a tray mechanism disposed to be retained within the lower portion. The tray mechanism may comprise at least one proximal slot and at least one distal slot, each disposed to retain a knife blade. Further, the tray bin mechanism may be disposed to provide a space to expose the handle of a knife in order to allow access for fingers to hold and remove knifes. The cutlery retaining apparatus may also comprise a cutting surface on an outer edge of the upper portion.

The tray mechanism may also include an upper portion comprising at least one upper utensil or silverware containment mechanism and a hinge mechanism disposed to join the lower tray mechanism and the upper portion in rotating communication. Furthermore, the upper portion may comprise a cutting board. And, the cutlery retaining apparatus may also comprise at numerous, but at least one tray bin mechanism, located within either the end portion or middle portion. Further, the tray bin mechanisms may comprise a distal tray bin mechanism and a proximal tray bin mechanism.

The cutlery retaining apparatus may also comprise an upper utensil or silverware retaining apparatus and a lower utensil or silverware retaining apparatus which are not connected in any manner wherein at least one upper utensil containment mechanism comprises an upper bin mechanism attached to the proximal end of the upper portion and a lower bin mechanism attached to the proximal end of the lower tray mechanism.

Moreover, the upper utensil containment mechanism may comprise an upper bin mechanism in rotatable communication with the upper portion for cantering in the outward direction in relation to the upper portion and wherein the upper portion comprises at least one support arm in communication with said upper bin. Additionally, the lower bin mechanism may be in rotatable communication with the lower tray portion and for cantering in the upward direction in relation to the lower portion.

Additionally, the cutlery holder may comprise a flat board mechanism containing holders and may also comprise a substantially rectangular box form. Further, the lower portion may comprise slots and bins and the tray may be removable and comprises matching slots and bins disposed to interlock with the slots and bins of the lower portion.

In an additional embodiment, illustrated is an integrated cutting board and cutlery retaining apparatus comprising a cutlery retaining apparatus, a lower tray disposed to be retained within the cutlery holder and at least one set retainer grooves. These retainer grooves may be disposed to retain at least one piece cutlery and disposed to allow access for fingers to hold and remove knifes.

Further, the integrated cutting board and cutlery retaining apparatus may comprise an upper cutting mechanism comprising an outer portion and an inner portion. Furthermore, the at least one set of statically opposed retainer grooves may comprise two sets of alternatingly, oppositely opposed, static retainer grooves which retain the blade end of a knife. Further, the lower tray may comprise a lower portion in mechanical communication with a set of support leg mechanisms.

In an additional embodiment, an integrated cutting board and cutlery retaining apparatus is illustrated and may comprises a lower tray mechanism comprising an upper surface which may comprise mechanisms for retaining cutlery which may include a hingedly attached upper member comprising an outer surface and an inner surface wherein the outer surface comprises a cutting board mechanism and the lower surface is in communication with at least one rotatably attached cutlery retaining mechanisms comprising at least one row of fixed slots disposed to house the blade of a knife and extend the handle outwardly. Additionally, the mechanisms for retaining cutlery may comprise clips and also may be selected from the group consisting of dish racks, silverware holders, and plate supports. And, the at least one row of fixed slots may also comprise two rows.

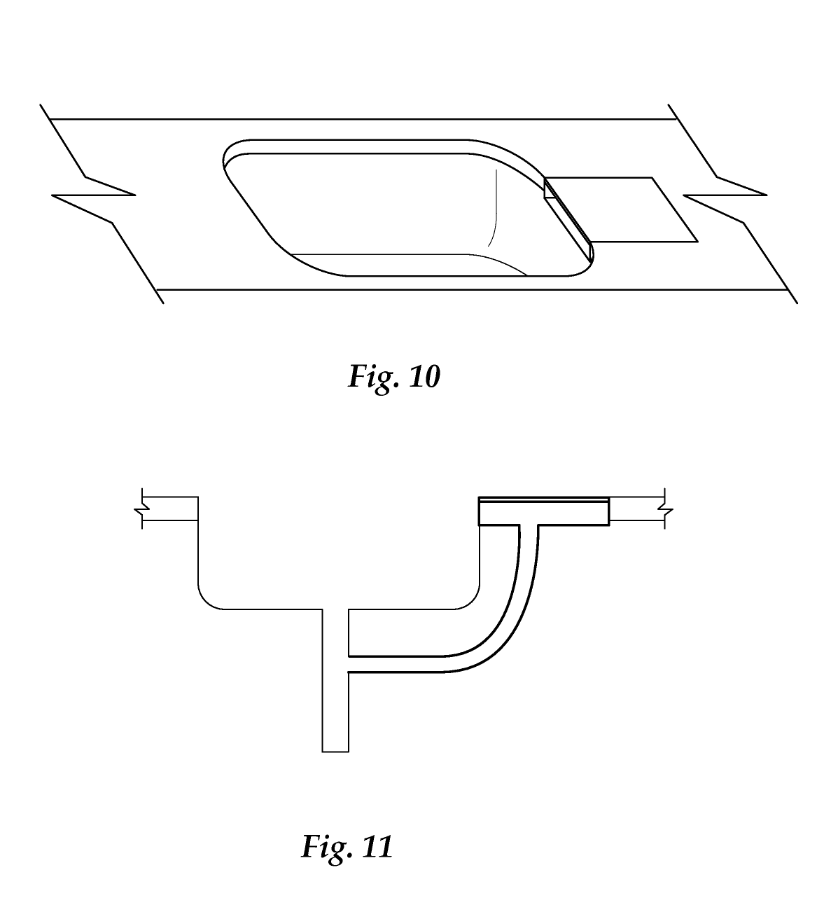

In still another embodiment an integrated cutting board and cutlery retaining apparatus is illustrated which comprises a portable embodiment and also a rigidly affixed embodiment which may exist as a permanent counter top, or as part of counter top and/or as part of a sink or even a kitchen island apparatus. FIG. 10 illustrates an isometric view of the multipurpose cutting board apparatus, wherein the instant apparatus is embedded within a sink or counter and wherein the water and refuse drains into the sink.

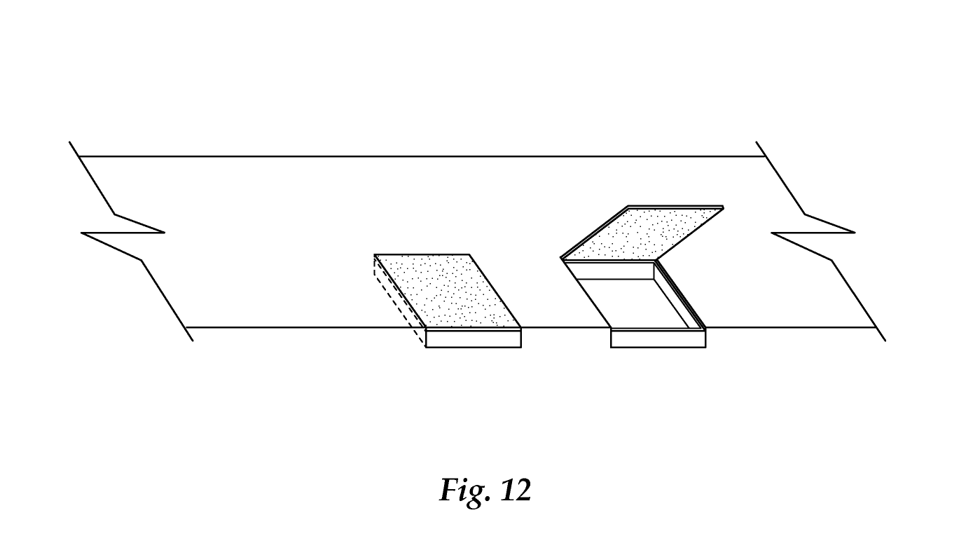

Additionally, FIG. 11 illustrates a side view of the multipurpose cutting board apparatus wherein the instant apparatus is embedded within a sink or counter, further illustrating a drainage system wherein the water is routed directly into the drainage system of the sink. FIG. 12 illustrates an isometric view of the multipurpose cutting board apparatus, illustrating two cutting boards, one in the open position and the other in the closed position.

I claim:

1. A cutlery retaining apparatus comprising:
a lower portion;
a tray mechanism disposed to be retained within the lower portion, wherein the tray mechanism comprises:
at least one slot wherein the at least one proximal slot is disposed to retain a knife blade;
at least one tray bin mechanism disposed to provide a space to expose the handle of a knife in order to allow access for fingers to hold and remove knifes;
an upper portion comprising at least one upper utensil containment mechanism; and,
a hinge mechanism disposed to join the lower tray mechanism and the upper portion in rotating communication.

2. The cutlery retaining apparatus of claim 1 wherein the upper portion comprises a cutting board.

3. The cutlery retaining apparatus of claim 1 wherein the at least one tray bin is located within a portion selected from the group consisting of the end portion and middle portion.

4. The cutlery retaining apparatus of claim 1 comprising an upper silverware retaining apparatus and a lower silverware retaining apparatus wherein the upper silverware retaining apparatus is not connected to the lower silverware retaining apparatus.

5. The cutlery retaining apparatus of claim 1 wherein the cutlery holder comprises a cutting surface on an outer edge of the upper portion.

6. The cutlery retaining apparatus of claim 1 wherein the at least one tray bin mechanism comprises a distal tray bin mechanism and a proximal tray bin mechanism.

7. The cutlery retaining apparatus of claim 1 wherein at least one upper utensil containment mechanism comprises an upper bin mechanism attached to the proximal end of the upper portion and a lower bin mechanism attached to the proximal end of the lower tray mechanism and wherein the at least one slot comprises at least one proximal slot and at least one distal slot wherein the at least one proximal slot is disposed to retain a knife blade and the at least one distal slot is disposed to retain a knife handle.

8. The cutlery retaining apparatus of claim 7 wherein the at least one upper utensil containment mechanism comprises an upper bin mechanism in rotatable communication with the upper portion for cantering in the outward direction in relation to the upper portion and wherein the upper portion comprises at least one support arm in communication with said upper bin.

9. The cutlery retaining apparatus of claim 7 wherein the lower bin mechanism is in rotatable communication with the lower tray portion and for cantering in the upward direction in relation to the lower portion.

10. The cutlery retaining apparatus of claim 1 wherein the cutlery holder comprises a flat board mechanism containing holders.

11. The cutlery retaining apparatus of claim 1 wherein the cutlery holder comprises a substantially rectangular box form.

12. The cutlery retaining apparatus of claim 1 wherein the lower portion comprises slots and bins.

13. The cutlery retaining apparatus of claim 1 wherein the tray is removable and comprises matching slots and bins disposed to interlock with the slots and bins of the lower portion.

14. An integrated cutting board and cutlery retaining apparatus comprising:
a cutlery retaining apparatus;
a lower tray disposed to be retained within the cutlery holder;
at least one set retainer grooves disposed to retain at least one piece cutlery and disposed to allow access for fingers to hold and remove knifes; and,
an upper cutting mechanism comprising an outer portion and an inner portion.

15. The integrated cutting board and cutlery retaining apparatus of claim 14 wherein the at least one set of statically opposed retainer grooves comprises two sets of alternatingly, oppositely opposed, static retainer grooves which retain the blade end of a knife.

16. The integrated cutting board and cutlery retaining apparatus of claim 14 wherein the lower tray comprises a lower portion in mechanical communication with a set of support leg mechanisms.

17. An integrated cutting board and cutlery retaining apparatus comprising:
a lower tray mechanism comprising an upper surface comprising mechanisms for retaining cutlery;
a hingedly attached upper member comprising an outer surface and an inner surface wherein the outer surface comprises a cutting board mechanism and the lower surface is in communication with at least one rotatably attached cutlery retaining mechanisms comprising at least one row of fixed slots disposed to house the blade of a knife and extend the handle outwardly.

18. The integrated cutting board and cutlery retaining apparatus of claim 17 wherein the mechanisms for retaining cutlery comprise clips.

19. The integrated cutting board and cutlery retaining apparatus of claim 17 wherein the mechanisms for retaining cutlery are selected from the group consisting of dish racks, silverware holders, and plate supports.

20. The integrated cutting board and cutlery retaining apparatus of claim 17 wherein the at least one row of fixed slots comprises two rows and wherein the integrated cutting board and cutlery retaining apparatus is rigidly affixed to part of counter top and a sink.

21. The integrated cutting board and cutlery retaining apparatus of claim 17 wherein the instant apparatus is embedded within a kitchen device selected from the group consisting of a sink, a counter or a kitchen island and wherein the water drains directly into the sink.

22. The integrated cutting board and cutlery retaining apparatus of claim 17 wherein the instant apparatus is embedded within a kitchen device selected from the group consisting of a sink, a counter or a kitchen island and wherein the water drains directly into a drainage pipe below the sink.
